(19) United States
(12) Patent Application Publication
(10) Pub. No.: US 2006/0080636 A1
(43) Pub. Date: Apr. 13, 2006

(54) METHOD OF BUILDING INTELLIGENT PLATFORM MANAGEMENT INTERFACE FIRMWARE ARCHITECTURE

(76) Inventor: Chih-Tao Hsieh, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/905,059

(22) Filed: Dec. 14, 2004

(30) Foreign Application Priority Data
Oct. 13, 2004 (TW) 093130941

(51) Int. Cl. G06F 9/44

(52) U.S. Cl. 717/101

(57) ABSTRACT

A method of building an intelligent platform management interface (IPMI) firmware architecture embedded in an IPMI hardware architecture, first uses a software program to edit the hardware architecture. The method then selects at least one hardware interface device, and defines environmental parameters between the firmware architecture and the IPMI hardware architecture. Then, a customized code is transmitted to the memory area of the hardware architecture in order to be stored in a classified catalog of the memory area. Thereafter, a translation device is used to translate the customized code into a general source code, and finally, the general source code and a core code are synchronously compiled to form a firmware object code. The firmware object code is linked to a program bank for building the executable IPMI firmware architecture.

### BACKGROUND OF INVENTION

1. Field of the Invention

The present invention relates to a method of building an intelligent platform management interface (IPMI) firmware architecture, and more particularly, to a method of building the IPMI firmware architecture using a core code and a customized code.

2. Description of the Prior Art

In the prior art, when a computer system administrator faces breakdowns of remote servers, such as the breakdown of a computing equipment in a telecommunication control room, and especially if it is an ISP server, the computer system administrator must go directly to the location of the remote server to repair or debug it. Such method costs a lot of manpower and time. To solve the above problem, related management techniques have been gradually developed for the remote server. One of the management techniques is called intelligent platform management interface (IPMI).

A typical IPMI mainly comprises a hardware architecture and a firmware architecture. The hardware architecture is a microcontroller having a baseboard management controller (BMC) in it, and the firmware architecture, which is embedded in the BMC, actually is a server management subsystem, but works independently from the hardware of the server. In other words, the firmware architecture works independently from the central processing unit (CPU), the basic input/output system (BIOS), the operating system (OS) and the system management software (SMS). Particularly, when the CPU, BIOS and OS of the server have failed, the server management subsystem becomes the interface between the control system management software and the platform management hardware.

However, in the prior art, the method of building the IPMI firmware architecture is to translate the customized code into binary code first, and link the binary code to the main core binary code of the IPMI to generate the final IPMI customized product. Please refer to FIG. 1, which shows a flowchart with steps of customizing the IPMI firmware according to the prior art. Step 100 first uses the application software interface to edit the selected hardware architecture for generating the source code. Step 102 compiles the source code corresponding to the hardware architecture and generates the binary code, wherein the binary code is in the form of machine code. Finally in step 104, the customized binary code and the main core binary code are combined to form the IPMI firmware with customized and core parts.

The above prior art must translate the customized source code into binary code first, and then integrate the binary code with the core part. Such method has two disadvantages. One is that the binary code is in the form of machine code. So when the user finds a mistake of the machine code and needs to correct it, because humans cannot readily read machine code, the user has no idea how to check and debug the program. The other one is that the compiling process is more complicated, because the prior art needs an extra step 102 to generate the transitional customized binary code to link to the main core binary code.

Therefore, a method of customizing the IPMI firmware, which simplifies the process of compiling the firmware and solves the problem of difficult debugging, becomes a topic that needs to be solved in the related industry.

### SUMMARY OF INVENTION

It is therefore an object of the claimed invention to provide a method of building the IPMI firmware architecture, which synchronously compiles the core code and the customized code in order to solve the problems above.

Another object of the claimed invention is to provide a method of building the IPMI firmware architecture, which synchronously compiles the core code and the customized code in order to simplify the process of building the firmware architecture.

According to the above objects, the claimed invention provides a method of building the IPMI firmware architecture, wherein the firmware architecture is embedded in the IPMI hardware architecture. The claimed invention uses a software program to edit the IPMI hardware architecture, selects at least one hardware interface device, and defines the environmental parameters between the firmware architecture and the IPMI hardware architecture to form the IPMI system architecture. Then, one customized code is transmitted to the memory area of the hardware architecture in order to be stored in the classified catalog of the memory area. Thereafter, a translation device is used to translate the customized code into a general source code. Finally, the general source code and the core code are synchronously compiled to form a firmware object code, and the firmware object code is then linked to the program bank for building the executable IPMI firmware architecture.

In the present invention, after synchronously compiling the general source code and the core code, the firmware architecture is loaded into a motherboard of a server. Then, the present invention tests the operation of the firmware architecture in the motherboard to verify the feasibility of the firmware architecture. If there is any problem shown in the testing of the firmware architecture, the present invention can directly modify the customized code or start debugging, and executes the step of translation and the step of synchronous compiling again to generate a firmware object code, and links the firmware object code to the program bank for building the executable IPMI firmware architecture.

Briefly, the present invention synchronously compiles the core code and the customized code in order to reduce difficulty in debugging and simplify the process of building the IPMI firmware architecture.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a flowchart that shows steps of customizing the IPMI firmware according to the prior art.

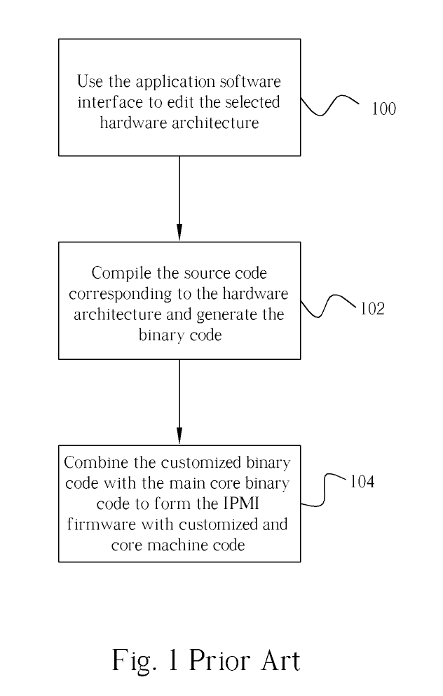

FIG. 2 is a functional block diagram of an intelligent platform management interface (IPMI) system architecture according to the present invention.

FIG. 3 is a flowchart that shows steps of customizing the IPMI firmware according to the present invention of FIG. 2.

### DETAILED DESCRIPTION

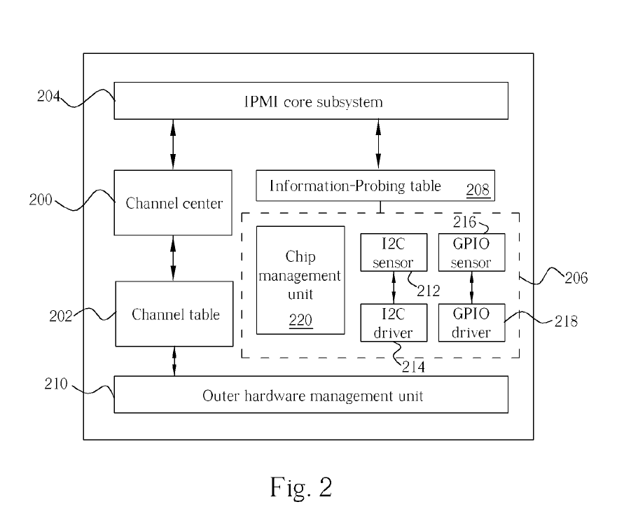

Please refer to FIG. 2, which shows an intelligent platform management interface (IPMI) system architecture according to the present invention, wherein the firmware architecture is embedded in the IPMI hardware architecture. The architecture is suitable for being used between a message source, such as a host system, and an operating end (not shown in FIG. 2). The IPMI system architecture of the present invention mainly comprises a channel center 200, a channel table 202, an IPMI core subsystem 204, a plurality of sensing/management units 206, and an information-probing table 208.

There is also a plurality of channel application interfaces (not shown in FIG. 2) in the channel center 200, such as IPMB or ICMB application interfaces. The channel center 200 uses a channel application interface to transmit or receive a channel message from the message source, and obtains an address pointer corresponding to the channel message. The channel table 202, which is coupled with the channel center 200, defines the channel application interface of the channel center 200 for updating the communication interface between the channel application interface and the outer hardware management unit 210. The channel table 202, such as a LAN/UART table, specifies the message, which passes through the universal asynchronous receiver transmitter (UART) application interface and the local area network (LAN) application interface.

The IPMI core subsystem 204, which is coupled with the channel center 200, processes the channel message, more particularly, the IPMI core subsystem 204 comprises a central message buffer unit, a message execution module and a memory control unit. The message execution module, which is coupled with the central message buffer unit, receives the address pointer corresponding to the channel message. The memory control unit, which is coupled with the message execution module, periodically inquires whether there is any newly sensed object in the memory of the sensing/management units 206 for obtaining the sensed object and storing it.

The plurality of sensing/management units 206, which is coupled with the IPMI core subsystem 204, is for sensing a physical change on a motherboard and storing the sensed object in a memory. The information-probing table 208, which is coupled with the IPMI core subsystem 204, defines the sensing parameters between the sensing/management units 206 and the IPMI core subsystem 204, and controls the sensing of the sensing/management units 206 according to the message execution module. The sensing/management unit 206 in the present invention, for example, could be an 12C sensor 212, an 12C driver 214, a GPIO sensor 216, a GPIO driver 218, and/or a chip management unit 220.

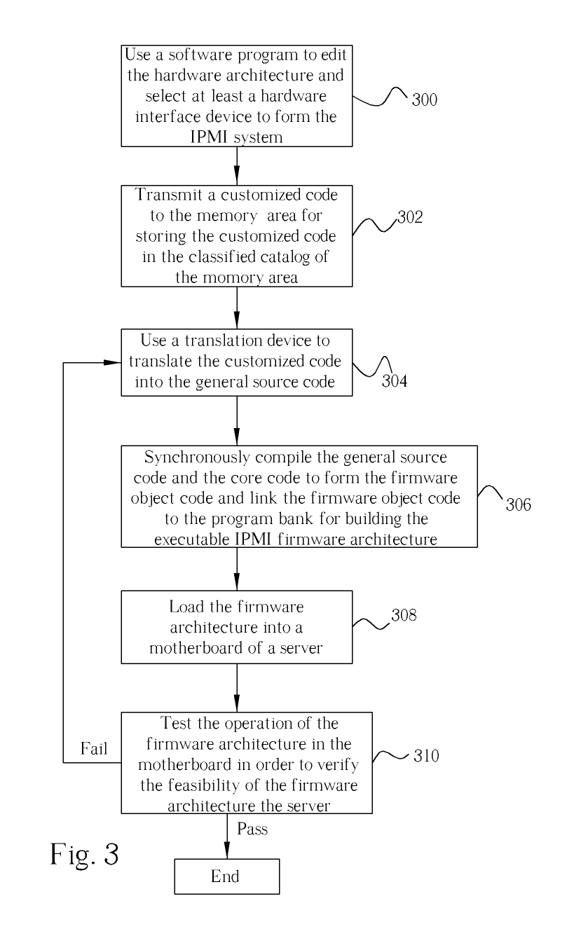

Please refer to FIG. 3, which shows a flowchart with steps of customizing the IPMI firmware according to the present invention of FIG. 2. FIG. 3 discloses a method of building the IPMI firmware architecture, wherein the firmware is embedded in the IPMI hardware architecture to form the IPMI system architecture. In step 300, the present invention first uses a software program to edit the hardware architecture, selects at least one hardware interface device, and defines the environmental parameters between the firmware architecture and the IPMI hardware architecture. The hardware interface device, for example, could be the above channel center 200 of the IPMI system architecture, the channel table 202, the IPMI core subsystem 204, a plurality of sensing/management units 206 and/or the information-probing table 208.

In step 302, the present invention transmits a customized code to the memory area for storing the customized code in the classified catalog of the memory area. In step 304, the translation device is used to translate the customized code into general source code. Finally, in step 306, the general source code and a core code are synchronously compiled to form the firmware object code, and the firmware object code is linked to the program bank for building the executable IPMI firmware architecture.

In the present invention, after synchronously compiling the general source code and the core code in step 306, step 108 loads the firmware architecture into a motherboard of a server. After that, step 310 tests the operation of the firmware architecture in the motherboard in order to verify the feasibility of the firmware architecture. When there is any problem shown in the testing of the firmware architecture, the present invention can directly modify the customized code or start debugging, and execute the translation of step 304 and the synchronous compiling of step 306 again to generate a firmware object code, before linking the firmware object code to the program bank for building the executable IPMI firmware architecture.

The core code of the present invention could be a source code or an object code. The general source code could be written in C Language (such as ANSI C or C+/C++, for example) or other high-level or low-level programming languages. In addition, before the synchronous compiling of step 306, there is a step of generating the channel table and the information-probing table corresponding to the hardware architecture. The customized code of the present invention comprises a driver and an instruction set. In step 304, the driver and the instruction set are combined and translated into the general source code.

Please notice that the core code and the customized code of the present invention use the address pointer, which is stored in the central message buffer unit, for message transmitting usage of the IPMI core subsystem 204. This reduces the number of times of the IPMI core subsystem 204 reading the above message, moreover, it improves the efficiency of the IPMI system 10. In addition, the message execution module of the present invention transmits the address pointer of the channel message to the memory control unit for starting processing.

The core code of the present invention relates to a hardware setting of the IPMI system architecture. It makes the motherboard of every server have a basic hardware environmental value; the content of the customized code is according to hardware requirements or other add-on application requirements of different users, for example the sensing/management unit, and can use the firmware architecture, which is formed with the customized code and the core code, for operating. The present invention synchronously compiles the combined code to simply the building process, compiling process, verification process and debugging process of the firmware architecture.

Overall, the present invention synchronously compiles the core code and the customized code to reduce difficulty in debugging and simplify the building process of the IPMI firmware architecture.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of building an intelligent platform management interface (IPMI) firmware architecture , wherein the firmware architecture is embedded in an IPMI hardware architecture to form an IPMI system architecture; the method comprising steps:
(a) using a software program to edit the IPMI hardware architecture, selecting at least one hardware interface device, and defining environmental parameters between the firmware architecture and the IPMI hardware architecture;
(b) transmitting at least one customized code to a memory area of the hardware architecture for storing the customized code in a classified catalog of the memory area;
(c) using a translation device to translate the customized code into a general source code; and
(d) synchronously compiling the general source code and a core code to form a firmware object code, and linking the firmware object code to a program bank for building the executable IPMI firmware architecture.

2. The method of claim 1, wherein the core code is an object code.

3. The method of claim 1 further comprising step of generating a channel table and an information-probing table corresponding to the hardware architecture before step (d).

4. The method of claim 1, wherein the customized code comprises at least one driver and at least one instruction set, which are combined to form the general source code.

5. The method of claim 1, wherein the general source code is written in C Language.

6. The method of claim 1 further comprising step of modifying the customized code according to the type or quantity of hardware interface devices in the hardware architecture, and executing steps (c) and (d) again after step (d).

7. The method of claim 1 further comprising step of loading the firmware architecture into a motherboard of a server after step (d).

8. The method of claim 7 further comprising step of testing the firmware architecture of the motherboard to verify feasibility of the firmware architecture after loading the firmware architecture into the motherboard.

9. A method of building an intelligent platform management interface (IPMI) firmware architecture, wherein the firmware architecture is embedded in an IPMI hardware architecture to form an IPMI system architecture; the method comprising steps:
(a) using a software program to edit the IPMI hardware architecture, selecting at least one hardware interface device, and defining environmental parameters between the firmware architecture and the IPMI hardware architecture;
(b) transmitting at least one customized code to a memory area of the hardware architecture for storing the customized code in a classified catalog of the memory area, wherein the customized code comprises at least one driver and at least one instruction set;
(c) using a translation device to translate the customized code into a general source code, facilitating the driver combine with the instruction set to form the general source code; and
(d) synchronously compiling the general source code and a core code to form a firmware object code, and liking the firmware object code to a program bank for building the executable IPMI firmware architecture.

10. The method of claim 9, wherein the core code is an object code.

11. The method of claim 9 further comprising step of generating a channel table and an information-probing table corresponding to the hardware architecture before step (d).

12. The method of claim 9, wherein the general source code is written in C Language.

13. The method of claim 9 further comprising step of modifying the customized code according to the type or quantity of hardware interface devices in the hardware architecture, and executing steps (c) and (d) again after step (d).

14. The method of claim 9 further comprising step of loading the firmware architecture into a motherboard of a serve after step (d).

15. The method of claim 14 further comprising step of testing the firmware architecture of the motherboard to verify feasibility of the firmware architecture after loading the firmware architecture into the motherboard.
